(19) United States
(12) Patent Application Publication
(10) Pub. No.: US 2013/0102330 A1
(43) Pub. Date: Apr. 25, 2013

(54) APPARATUS AND METHOD FOR PROVIDING ADVERTISEMENT DATA IN MOBILE TERMINAL, AND SYSTEM THEREOF

(71) Applicant: Samsung Electronics Co., Ltd., Gyeonggi-do (KR)

(72) Inventor: Do-Hyung LEE, Seoul (KR)

(73) Assignee: Samsung Electronics Co., Ltd., Gyeonggi-do (KR)

(21) Appl. No.: 13/659,287

(22) Filed: Oct. 24, 2012

(30) Foreign Application Priority Data
Oct. 24, 2011 (KR) 10-2011-0109018

(51) Int. Cl. H04W 24/00

(52) U.S. Cl. 455/456.3

(57) ABSTRACT

An apparatus and method for providing advertisement data in a mobile terminal, and a system thereof are provided. If a Location Based Service (LBS) service is running, an advertising server measures a moving speed of the mobile terminal, compares the measured moving speed with a reference speed, selectively generates first advertisement data including one or more of image advertisement data and video advertisement data or second advertisement data including voice advertisement data based on the comparison results, and transmits the generated advertisement data. The mobile terminal selectively receives and outputs the first or second advertisement data from the advertising server.

### PRIORITY

This application claims priority under 35 U.S.C. §119(a) to a Korean Patent Application filed in the Korean Intellectual Property Office on Oct. 24, 2011 and assigned Serial No. 10-2011-0109018, the contents of which are hereby incorporated by reference.

### BACKGROUND OF THE INVENTION

1. Field of the Invention

The present invention relates generally to a mobile terminal, and more particularly, to an apparatus and method for providing advertisement data in a mobile terminal, and a system thereof.

2. Description of the Related Art

A mobile terminal supporting Location Based Service (LBS) generally offers its user an advertising service providing voice, image or video advertisement data together with a navigation service providing a map of the current location and route information of the mobile terminal.

The advertising service provides voice, image and video advertisement data regardless of the moving speed of a mobile terminal mounted in a vehicle. Even when the vehicle moves at high speed, the mobile terminal provides image and video advertisement data on a screen supporting LBS.

Since the user may desire the LBS service rather than the advertising service while the vehicle moves at high speed, providing the advertisement data may interfere with providing the desired LBS service.

Accordingly, there is a need in the art for an advertisement data providing apparatus and method capable of increasing advertising efficiency without interfering with the LBS service.

### SUMMARY OF THE INVENTION

An aspect of the present invention is to provide an apparatus and method for providing advertisement data in different formats depending on a moving speed of a mobile terminal, and a system thereof.

Another aspect of the present invention is to provide an apparatus and method for providing advertisement data without interfering with an LBS service being provided at a high moving speed of a mobile terminal, and a system thereof.

Another aspect of the present invention is to provide an apparatus and method for providing optimally efficient advertisement data at a low moving speed of a mobile terminal, and a system thereof.

In accordance with an aspect of the present invention, there is provided a system for providing advertisement data in a mobile terminal, including an advertising server for measuring, when an LBS service is running, a moving speed of the mobile terminal, comparing the measured moving speed with a reference speed, selectively generating first advertisement data including one or more of image advertisement data and video advertisement data or second advertisement data including voice advertisement data based on the comparison results, and transmitting the generated advertisement data, and the mobile terminal for selectively receiving the first or second advertisement data from the advertising server and outputting the received advertisement data.

In accordance with an aspect of the present invention, there is provided an apparatus for providing advertisement data in a mobile terminal, including a memory, and a controller for selectively receiving, when an LBS service is running, first or second advertisement data from an advertising server based on a comparison between a moving speed of the mobile terminal and a reference speed, and outputting the received advertisement data. The first advertisement data may include one or more of image advertisement data and video advertisement data, and the second advertisement data may include voice advertisement data.

In accordance with an aspect of the present invention, there is provided a method for providing advertisement data in a mobile terminal, including measuring a moving speed of the mobile terminal by an advertising server, comparing the measured moving speed with a reference speed when an LBS service is running, selectively generating first advertisement data including one or more of image advertisement data and video advertisement data or second advertisement data including voice advertisement data based on the comparison results, and transmitting the generated advertisement data, and selectively receiving, by the mobile terminal, the first or second advertisement data from the advertising server, and outputting the received advertisement data.

### BRIEF DESCRIPTION OF THE DRAWINGS

The above and other aspects, features and advantages of embodiments of the present invention will be more apparent from the following description taken in conjunction with the accompanying drawings, in which:

FIG. 1 illustrates a wireless communication system according to an embodiment of the present invention;

FIG. 2 illustrates a mobile terminal according to an embodiment of the present invention;

FIG. 3 illustrates advertisement data in a mobile terminal according to a first embodiment of the present invention;

FIG. 4 illustrates advertisement data in a mobile terminal according to a second embodiment of the present invention;

FIG. 5 illustrates a screen outputting advertisement data in a mobile terminal according to an embodiment of the present invention; and

FIG. 6 illustrates a screen outputting advertisement data in a mobile terminal according to an embodiment of the present invention.

### DETAILED DESCRIPTION OF EMBODIMENTS OF THE INVENTION

Embodiments of the present invention will now be described in detail with reference to the accompanying drawings. Herein, descriptions of well-known functions and constructions are omitted for the sake of clarity and conciseness.

A mobile terminal, to which embodiments of the present invention are applicable, may include mobile electronic devices such as video phones, cell phones, smart phones, International Mobile Telecommunication 2000 (IMT-2000) terminals, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, E-Books, portable computers (e.g., notebook computers and tablet computers), digital cameras, and Head Up Displays (HUDs).

It will be assumed herein that a mobile terminal supports LBS.

The term ‘LBS’ as used herein refers to a system that provides various services to users based on location information acquired from mobile communication networks or Global Positioning System (GPS). For example, when a mobile terminal supporting LBS is mounted in a vehicle, the mobile terminal may provide LBS, which indicates the current location of the vehicle and the path from the current location to the destination.

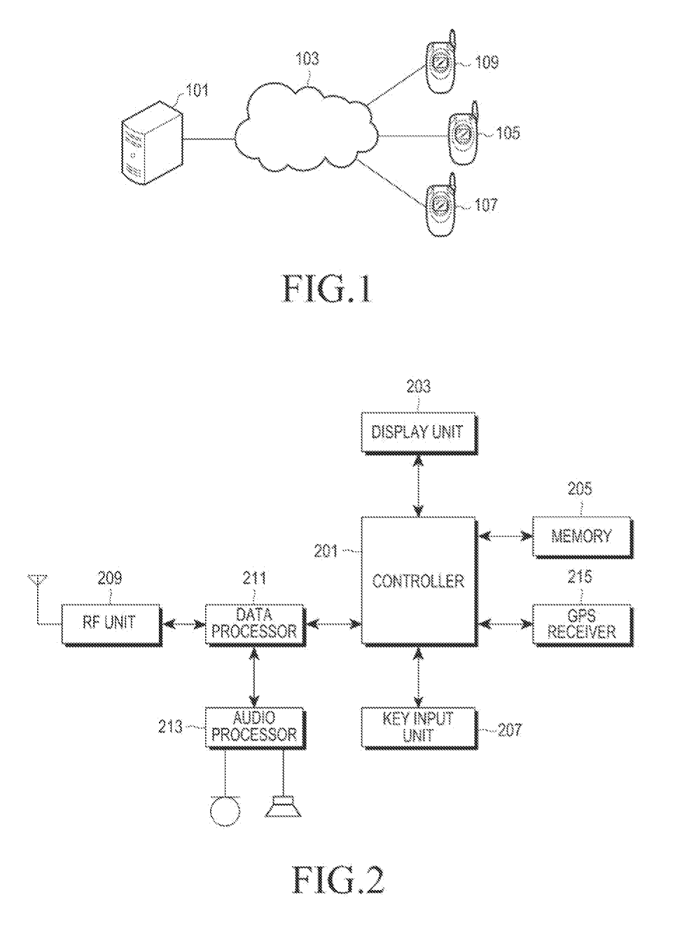

FIG. 1 illustrates a wireless communication system according to an embodiment of the present invention.

Referring to FIG. 1, the wireless communication system includes an advertising server 101, a wireless communication network 103, and first to third mobile terminals 105, 107 and 109.

The advertising server 101 transmits advertisement data to the mobile terminals 105, 107 and 109 that are running an LBS service.

More specifically, in a first embodiment of the present invention, if the first mobile terminal 105 runs the LBS service, the advertising server 101 transmits advertisement data including video advertisement data, image advertisement data and voice advertisement data to the first mobile terminal 105.

In a second embodiment of the present invention, if the first mobile terminal 105 runs the LBS service, the advertising server 101 measures a moving speed of the first mobile terminal 105. If the measured moving speed is greater than a reference speed, the advertising server 101 transmits advertisement data including voice advertisement data to the first mobile terminal 105. If the measured moving speed is equal to or less than the reference speed, the advertising server 101 transmits advertisement data including video advertisement data or image advertisement data to the first mobile terminal 105. The reference speed may be 3 km/h or 5 km/h, for example.

The advertising server 101 measures a moving distance of the first mobile terminal 105 for a time period, and calculates a moving speed of the first mobile terminal 105 based on the measured moving distance and the time period.

For example, the advertising server 101 may receive from a base station or from the first mobile terminal 105 an identifier of one or more cell that the first mobile 105 has passed through for a time period, and determine a moving distance of the first mobile terminal 105 based on cell coverage corresponding to the received cell identifier. As another example, the advertising server 101 may receive one or more GPS coordinates of the first mobile terminal 105 for a time period, and determine a moving distance of the first mobile terminal 105 based on the received GPS coordinates.

The wireless communication network 103 exchanges data with the advertising server 101 and the first to third mobile terminals 105, 107 and 109. More specifically, the wireless communication network 103 receives advertisement data from the advertising server 101, and transmits the received advertisement data to a mobile terminal running LBS among the first to third mobile terminals 105, 107 and 109.

The first to third mobile terminals 105, 107 and 109 each receives advertisement data from the advertising server 101 through the wireless communication network 103, and outputs the received advertisement data.

More specifically, in the first embodiment, the first mobile terminal 105, which is running LBS, receives and stores advertisement data including voice advertisement data, image advertisement data and video advertisement data, and measures its moving speed for a time period. The first mobile terminal 105 may measure its moving speed using a speed sensor, or based on GPS coordinates that have been received through a GPS receiver.

If the measured moving speed exceeds a reference speed, the first mobile terminal 105 outputs audio advertisement data in the stored advertisement data. If the measured moving speed is equal to or less than the reference speed, the first mobile terminal 105 outputs image advertisement data and video advertisement data in the stored advertisement data. The reference speed may be 3 km/h or 5 km/h, for example.

In the second embodiment, when running LBS, the first mobile terminal 105 transmits its moving information to the advertising server 101 so that the advertising server 101 may measure a moving speed of the first mobile terminal 105. The moving information may include an identifier of one or more cells that the first mobile terminal 105 has passed through for a time period, or may include one or more GPS coordinates that the first mobile terminal 105 has received for a time period.

If it is determined by the advertising server 101 that the moving speed of the first mobile terminal 105 is greater than the reference speed, the first mobile terminal 105 receives advertisement data including voice advertisement data from the advertising server 101 and outputs the received advertisement data. If it is determined by the advertising server 101 that the moving speed of the first mobile terminal 105 is equal to or less than the reference speed, the first mobile terminal 105 receives advertisement data including image advertisement data or video advertisement data from the advertising server 101 and outputs the received advertisement data.

FIG. 2 illustrates a mobile terminal according to an embodiment of the present invention.

Referring to FIG. 2, the mobile terminal includes a controller 201, a display unit 203, a memory 205, a key input unit 207, a wireless transceiver (or Radio Frequency (RF) Unit) 209, a data processor 211, an audio processor 213, and a GPS receiver 215.

The wireless transceiver 209 performs a wireless communication perform of the mobile terminal. More specifically, the wireless transceiver 209 includes a wireless transmitter (not shown) for up-converting a frequency of transmission signals and amplifying the up-converted transmission signals, and a wireless receiver (not shown) for low-noise-amplifying received signals and down-converting a frequency of the amplified signals. The data processor 211 includes a transmitter (not shown) for coding and modulating transmission signals, and a receiver (not shown) for demodulating and decoding received signals. The data processor 211 may include a modulator/demodulator (modem) and a coder/decoder (codec) (not shown), and the codec may include a data codec for processing data signals such as packet data, and an audio codec for processing audio signals such as voice.

The audio processor 213 plays received audio signals output from the data processor 211 using a speaker, and transfers audio transmission signals picked up by a microphone to the data processor 211. The key input unit 207 includes alphanumeric keys for inputting alphanumeric and image information and function keys for setting various functions. The display unit 203 displays image signals on its screen, and displays requested data output from the controller 201 on the screen. If the display unit 203 has a capacitive touch screen or a resistive touch screen, the key input unit 207 may include a minimum number of keys and the display unit 203 may partially replace the key input function of the key input unit 207.

The GPS receiver 215 receives GPS signals from a plurality of GPS satellites, generates GPS coordinates based on the received GPS signals, and outputs the generated GPS coordinates to the controller 201. The memory 205 includes a program memory (not shown) and a data memory (not shown). The program memory stores booting and Operating System (OS) programs for controlling the general operations of the mobile terminal, and the data memory stores data generated during an operation of the mobile terminal.

In particular, the memory 205 stores advertisement data received from the advertising server 101. In a first embodiment, the memory 205 stores advertisement data including video advertisement data, voice advertisement data and image advertisement data, and if it is determined by the controller 201 that a moving speed of the mobile terminal is greater than a reference speed, the memory 205 searches for voice advertisement data in the stored advertisement data, and outputs the searched advertisement data to the controller 201. If it is determined by the controller 201 that a moving speed of the mobile terminal is equal to or less than the reference speed, the memory 205 searches for video advertisement data or image advertisement data in the stored advertisement data, and outputs the searched advertisement data to the controller 201.

In a second embodiment, if it is determined by the advertising server 101 that a moving speed of the mobile terminal is greater than the reference speed, the memory 205 receives voice advertisement data from the advertising server 101, stores the received voice advertisement data, and outputs the stored voice advertisement data to the controller 201. If it is determined by the advertising server 101 that a moving speed of the mobile terminal is equal to or less than the reference speed, the memory 205 receives image advertisement data or video advertisement data from the advertising server 101, stores the received advertisement data, and outputs the stored image or video advertisement data to the controller 201.

The controller 201 controls the overall operation of the mobile terminal. In particular, the controller 201 outputs different types of advertisement data depending on a moving speed of the mobile terminal.

More specifically, in the first embodiment, when running LBS, the controller 201 provides LBS based on GPS coordinates received from the GPS receiver 215, and sends an LBS running notification message to the advertising server 101. Upon receiving advertisement data including voice advertisement data, image advertisement data and video advertisement data from the advertising server 101, the controller 201 measures a moving speed of the mobile terminal.

The controller 201 may measure a moving speed of the mobile terminal for a time period using a speed sensor (not shown) mounted in the mobile terminal. In the alternative, the controller 201 may determine a moving distance of the mobile terminal for a time period based on one or more GPS coordinates received for a time period, and determine a moving speed of the mobile terminal by dividing the determined moving distance by the time period.

If the measured moving speed is greater than a reference speed, the controller 201 detects voice advertisement data from the advertisement data stored in the memory 205, and outputs the detected voice advertisement data through the audio processor 213. If the measured moving speed is equal to or less than the reference speed, the controller 201 detects image advertisement data or video advertisement data from the advertisement data stored in the memory 205, and outputs the detected image or video advertisement data on the display 203.

In the second embodiment, when running LBS, the controller 201 provides LBS based on GPS coordinates received from the GPS receiver 215. After sending an LBS running notification message to the advertising server 101, the controller 201 receives first advertisement data including only voice advertisement data, or second advertisement data including image advertisement data or video advertisement data from the advertising server 101, and stores the received advertisement data in the memory 205. Upon receiving the first advertisement data from the advertising server 101, the controller 201 outputs the first advertisement data through the audio processor 213. Upon receiving the second advertisement data from the advertising server 101, the controller 201 outputs the second advertisement data on the display 203.

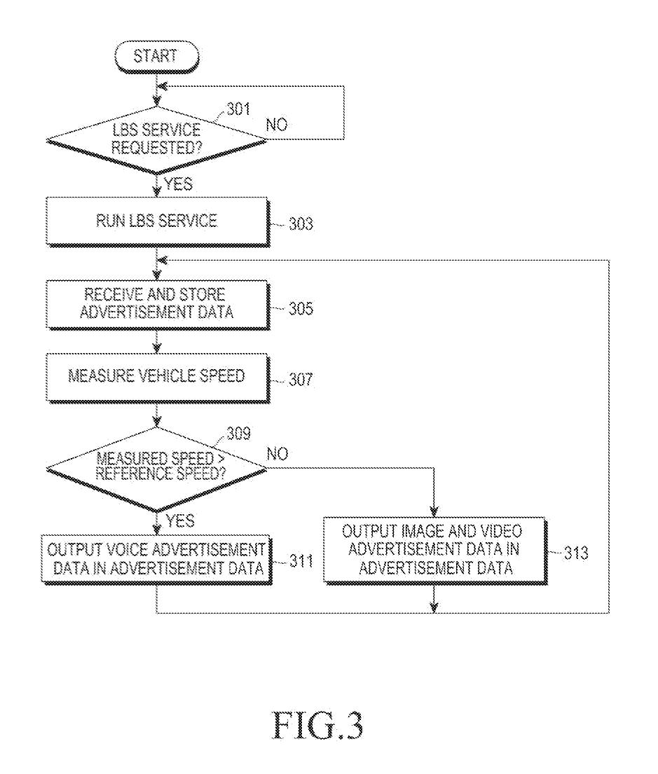

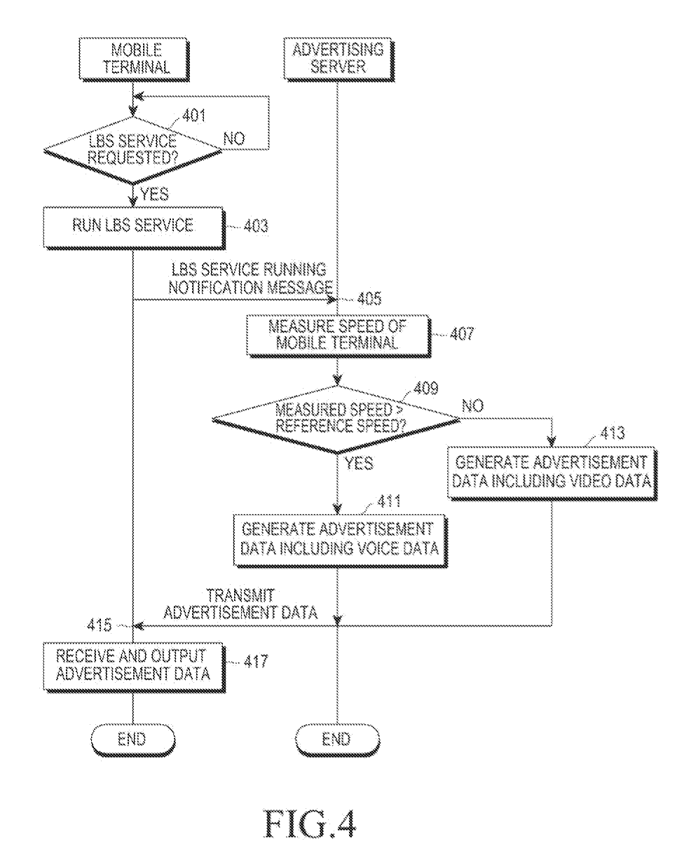

FIG. 3 illustrates advertisement data in a mobile terminal according to a first embodiment of the present invention.

In step 301, the mobile terminal determines whether LBS is running by a user. If LBS is running, the mobile terminal proceeds to step 303, and otherwise, repeats step 301.

In step 303, the mobile terminal provides LBS based on GPS coordinates received from the GPS receiver 215, and sends an LBS running notification message to the advertising server 101. The LBS running notification message is a message notifying that the mobile terminal has run LBS.

In step 305, the mobile terminal receives advertisement data including voice advertisement data, image advertisement data and video advertisement data from the advertising server 101, and stores the received advertisement data.

In step 307, the mobile terminal measures its moving speed for a time period. The mobile terminal may calculate its moving speed for a time period using a speed sensor mounted therein. In the alternative, the mobile terminal may determine its moving distance for a time period based on one or more GPS coordinates received for a time period, and calculate its moving speed by dividing the determined moving distance by the time period.

In step 309, the mobile terminal compares the measured speed with a reference speed. If the measured speed is greater than the reference speed, the mobile terminal proceeds to step 311. If the measured speed is equal to or less than the reference speed, the mobile terminal proceeds to step 313. The reference speed may be set as 3 km/h or 5 km/h, for example.

In step 311, the mobile terminal detects voice advertisement data in the stored advertisement data and outputs the detected advertisement data, determining that a vehicle equipped with the mobile terminal moves at high speed, and then returns to step 305.

In step 313, the mobile terminal detects image advertisement data and/or video advertisement data in the stored advertisement data and outputs the detected advertisement data, determining that the vehicle equipped with the mobile terminal moves at low speed, and then returns to step 305.

FIG. 4 illustrates advertisement data in a mobile terminal according to a second embodiment of the present invention.

Referring to FIG. 4, the mobile terminal determines in step 401 whether a user is requesting LBS. If LBS is being requested, the mobile terminal proceeds to step 403, and otherwise, repeats step 401.

In step 403, the mobile terminal provides LBS based on GPS coordinates received from the GPS receiver 215. In step 405, the mobile terminal sends an LBS running notification message to the advertising server 101. The LBS running notification message is for notifying that the mobile terminal has run LBS.

In step 407, upon receiving the LBS running notification message, the advertising server 101 measures a moving speed of the mobile terminal that has sent the LBS running notification message. The advertising server 101 may calculate a moving distance of the mobile terminal for a time period, and calculate a moving speed of the mobile terminal based on the calculated moving distance and the time period.

For example, the advertising server 101 may receive from a base station or from the mobile terminal an identifier of one or more cells through which the mobile terminal has passed for a time period, and determine a moving distance of the mobile terminal based on cell coverage corresponding to the received cell identifier. As another example, the advertising server 101 may receive from the mobile terminal one or more GPS coordinates that the mobile terminal has received from a satellite navigation system for a time period, and determine a moving distance of the mobile terminal based on the received GPS coordinates.

In step 409, the advertising server 101 compares the measured moving speed with the reference speed. If the measured moving speed is greater than the reference speed, the advertising server 101 proceeds to step 411. If the measured moving speed is equal to or less than the reference speed, the advertising server 101 proceeds to step 413. The reference speed may be set as 3 km/h or 5 km/h, for example.

In step 411, the advertising server 101 generates advertisement data including voice advertisement data, determining that the mobile terminal moves at high speed.

In step 413, the advertising server 101 generates advertisement data including image advertisement data and video advertisement data, determining that the mobile terminal moves at low speed.

In step 415, the advertising server 101 transmits the advertisement data generated in step 411 or 413 to the mobile terminal.

In step 417, the mobile terminal receives the advertisement data from the advertising server 101, stores the received advertisement data, and outputs the stored advertisement data. If the advertisement data includes only voice advertisement data, the mobile terminal outputs the voice advertisement data through the audio processor 213 using a speaker. If the advertisement data includes only video advertisement data, the mobile terminal outputs the video advertisement data on the display 203.

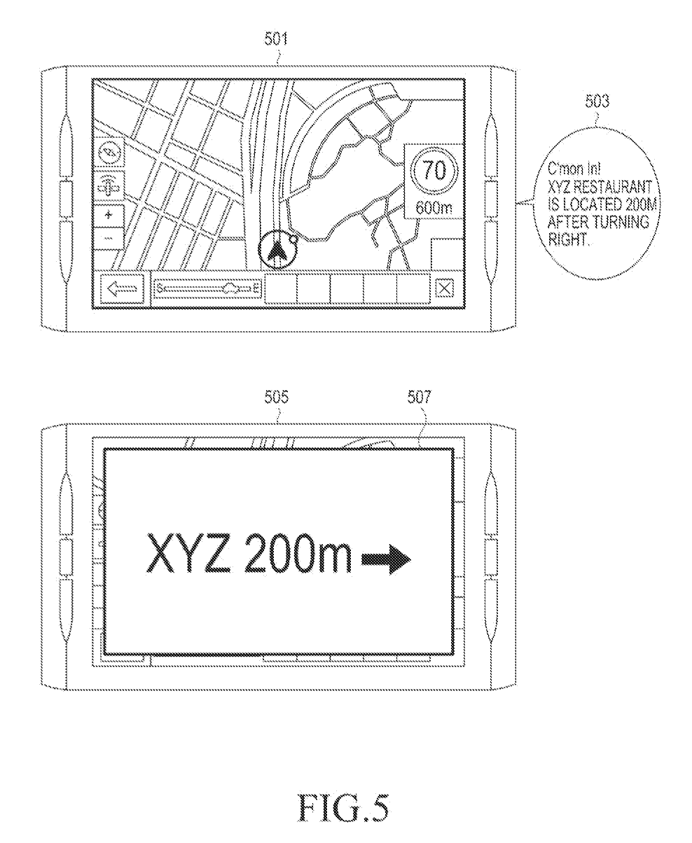

FIG. 5 illustrates a screen outputting advertisement data in a mobile terminal according to an embodiment of the present invention.

Reference numeral 501 represents an illustrative screen providing LBS, and reference numeral 503 represents an illustrative speech bubble providing voice advertisement data. For example, if a moving speed of the mobile terminal is greater than a reference speed, the mobile terminal may output the speech bubble 503 in voice while displaying the screen 501.

If it is determined that the mobile terminal moves at high speed, the mobile terminal provides the LBS service and the advertising service to the user simultaneously by providing the user with advertisement data only in voice.

Reference numeral 505 represents an illustrative screen providing LBS, and reference numeral 507 represents an illustrative screen providing image advertisement data. For example, if a moving speed of the mobile terminal is equal to or less than a reference speed, the mobile terminal may output image or video advertisement data on the screen 505.

In other words, if it is determined that the mobile terminal moves at low speed, the mobile terminal may efficiently provide the advertising service to the user by providing image or video advertisement data to the user.

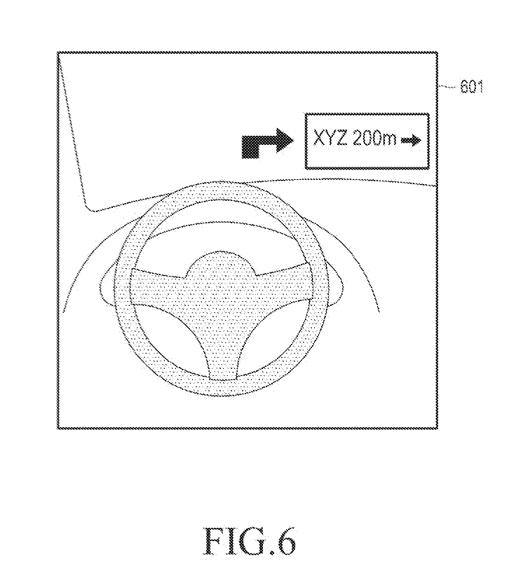

FIG. 6 illustrates a screen outputting advertisement data in a mobile terminal according to an embodiment of the present invention.

Reference numeral 601 represents an illustrative screen that provides advertisement data on the front glass of a vehicle when the mobile terminal is a Head-Up Display (HUD) device. For example, if a moving speed of the mobile terminal is equal to or less than a reference speed, the mobile terminal may output image or video advertisement data on the screen 601.

In other words, if it is determined that the mobile terminal moves at low speed, the mobile terminal may efficiently provide the advertising service to the user by providing image or video advertisement data to the user.

In summary, based on the operations of outputting voice advertisement data at a high moving speed of a mobile terminal and outputting image or video advertisement data at a low moving speed of the mobile terminal, the present invention provides an apparatus and method for providing advertisement data in different formats depending on a moving speed of the mobile terminal, and also provides an apparatus and method for providing advertisement data without interfering with LBS being provide at a high moving speed of the mobile terminal, and providing advertisement data at its highest efficiency at a low moving speed of the mobile terminal.

As is apparent from the foregoing description, the present invention provides advertisement data in different formats depending on a moving speed of a mobile terminal.

The present invention provides advertisement data without interfering with LBS being provided at a high moving speed of a mobile terminal.

The present invention provides advertisement data at its highest efficiency at a low moving speed of a mobile terminal.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A system for providing advertisement data in a mobile terminal, comprising:
an advertising server for measuring, if a Location Based Service (LBS) service is running, a moving speed of the mobile terminal, comparing the measured moving speed with a reference speed, selectively generating first advertisement data including one or more of image advertisement data and video advertisement data and second advertisement data including voice advertisement data based on the comparison results, and transmitting the generated advertisement data; and
the mobile terminal for selectively receiving the first or second advertisement data from the advertising server and outputting the received advertisement data.

2. The system of claim 1, wherein the mobile terminal receives and outputs the first advertisement data if the moving speed is equal to or less than the reference speed.

3. The system of claim 1, wherein the mobile terminal receives and outputs the second advertisement data if the moving speed exceeds the reference speed.

4. The system of claim 1, wherein the moving speed is measured based on cell information of the mobile terminal.

5. An apparatus for providing advertisement data in a mobile terminal, comprising:
a memory; and
a controller for selectively receiving, if a Location Based Service (LBS) service is running, first or second advertisement data from an advertising server based on a comparison between a moving speed of the mobile terminal and a reference speed, and outputting the received advertisement data,
wherein the first advertisement data includes one or more of image advertisement data and video advertisement data, and the second advertisement data includes voice advertisement data.

6. The apparatus of claim 5, wherein the controller receives and outputs the first advertisement data if the moving speed is equal to or less than the reference speed.

7. The apparatus of claim 5, wherein the controller receives and outputs the second advertisement data if the moving speed exceeds the reference speed.

8. The apparatus of claim 5, wherein the moving speed is measured by the advertising server based on cell information of the mobile terminal.

9. A method for providing advertisement data in a mobile terminal, comprising:
measuring, by an advertising server, a moving speed of the mobile terminal, if a Location Based Service (LBS) service is running;
comparing the measured moving speed with a reference speed;
selectively generating first advertisement data including one or more of image advertisement data and video advertisement data or second advertisement data including voice advertisement data based on the comparison results, and transmitting the generated advertisement data; and
selectively receiving, by the mobile terminal, the first or second advertisement data from the advertising server, and outputting the received advertisement data.

10. The method of claim 9, wherein selectively receiving and outputting comprises receiving and outputting the first advertisement data if the moving speed is equal to or less than the reference speed.

11. The method of claim 9, wherein selectively receiving and outputting comprises receiving and outputting the second advertisement data if the moving speed exceeds the reference speed.

12. The method of claim 9, wherein the moving speed is measured based on cell information of the mobile terminal.
